(19) United States
(12) Patent Application Publication
(10) Pub. No.: US 2009/0008948 A1
(43) Pub. Date: Jan. 8, 2009

(54) ELECTRONIC APPARATUS

(75) Inventors: Chia-Ju Ho, Taipei City (TW); Chih-Chin Yu, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/021,847

(22) Filed: Jan. 29, 2008

(30) Foreign Application Priority Data
Jul. 6, 2007 (TW) 96124688

(51) Int. Cl. E05C 1/08; H02B 1/04

(52) U.S. Cl. 292/179; 361/600

(57) ABSTRACT

An electronic apparatus includes a main body, a detachable object, a sliding latch element, and an elastic element. The main body has an accommodating space. The detachable object is suitable for sliding in a direction to be disposed in the accommodating space. The sliding latch element is suitable for sliding between a first position and a second position. The elastic element connects the sliding latch element and the main body. When the sliding latch element is at the second position, a first locking part of the detachable object does not lock a second locking part of the sliding latch element, a first limit part of the detachable object blocks a second limit part of the sliding latch element, and a third limit part of the sliding latch element restricts a protrusion of the detachable object such that a portion of the detachable object is exposed outside the accommodating space.

### CROSS-REFERENCE TO RELATED APPLICATION

This application claims the priority benefit of Taiwan application serial no. 96124688, filed on Jul. 6, 2007. The entirety of the above-mentioned patent application is hereby incorporated by reference herein and made a part of this specification.

### BACKGROUND OF THE INVENTION

1. Field of the Invention

The present invention relates to an electronic apparatus, and more particularly relates to an electronic apparatus having a detachable object.

2. Description of Related Art

Portable computers, different from conventional desktop computers, are required to be light, thin, short, and small. A portable computer can be carried by a user, such that the user can use the portable computer in different working environments.

When the user wants to use the portable computer in a working environment without external power sources, a battery of the portable computer can provide power to the portable computer such that the user can use the portable computer. However, in some cases, for example, when the user removes the battery to reduce the weight of the portable computer for carrying along, the user must move a locking element that locks element that locks the battery to take out the battery. But, the steps of taking out the battery are quite complex. Moreover, the battery, when being taken out, may go back to its original position due to an improperly applied force or the weight of the battery itself. In addition, in the conventional portable computer, the battery may be pushed back when it is not completely taken out, resulting in the loose electrical contact that is not easy to be perceived between the battery and the host device of the portable computer.

### SUMMARY OF THE INVENTION

The present invention is directed to an electronic apparatus having a detachable object. It is convenient for the user to detach the detachable object.

The present invention provides an electronic apparatus, including a main body, a detachable object, a sliding latch element, and an elastic element. The main body has an accommodating space. The detachable object is suitable for sliding in a direction to be disposed in the accommodating space. The detachable object has a first limit part, a first locking part, and a protrusion. The first limit part has a first slope at an angle with respect to the above direction.

The sliding latch element is suitable for sliding between a first position and a second position. The sliding latch element includes a flexible part, a second limit part, a third limit part, and a second locking part. The second limit part is disposed on the flexible part, and has a second slope. The elastic element connects the sliding latch element and the main body.

When the sliding latch element is at the first position, the detachable object is fixed in the accommodating space by means of the first locking part locking the second locking part, and the first slope faces the second slope. When the sliding latch element is at the second position, the first locking part does not lock the second locking part, the first limit part blocks the second limit part, and the third limit part restricts the move of the protrusion along the direction, such that a portion of the detachable object is exposed outside the accommodating space.

In an embodiment of the present invention, the first limit part may be a wedge, and the second limit part may be a wedge.

In an embodiment of the present invention, the protrusion may be a block.

In an embodiment of the present invention, the third limit part may have a third slope, and the sliding latch element further includes a fourth limit part having a fourth slope. When the sliding latch element is at the first position and the detachable object is fixed in the accommodating space, the third slope faces the fourth slope. In addition, the first slope, the second slope, the third slope, and the fourth slope are parallel to one another. Moreover, the third limit part may be a wedge, and the fourth limit part may be a wedge.

Furthermore, when the sliding latch element is at the first position and the detachable object is fixed in the accommodating space, a first distance between a first top surface of the first limit part and a second top surface of the second limit part is greater than a second distance between a third top surface of the third limit part and a fourth top surface of the fourth limit part. A third distance between a first side surface of the first limit part and a second side surface of the second limit part is greater than a fourth distance between a third side surface of the third limit part and a fourth side surface of the fourth limit part. When the sliding latch element is at the second position, the first side surface contacts the second side surface, and the third side surface faces the fourth side surface.

In an embodiment of the present invention, the flexible part may be a flexible cantilever.

In an embodiment of the present invention, the first locking part may be a locking hook, and the second locking part may be a locking hook.

In an embodiment of the present invention, the first locking part may be a locking hook, and the second locking part may be a locking slot.

In an embodiment of the present invention, the first locking part may be a locking slot, and the second locking part may be a locking hook.

As a user may move the sliding latch element to take out the detachable object, the user can take out the detachable object conveniently. Furthermore, when the sliding latch element is at the second position, the third limit part of the sliding latch element restricts the protrusion of the detachable object, such that the detachable object does not slide to be disposed in the accommodating space of the main body. Therefore, the detachable object will not easily go back to the original position due to the improperly applied force or the weight of the detachable object.

In order to make the aforementioned features and advantages of the present invention comprehensible, embodiments accompanied with the drawings are described in detail below.

It is to be understood that both the foregoing general description and the following detailed description are exemplary, and are intended to provide further explanation of the invention as claimed.

### BRIEF DESCRIPTION OF THE DRAWINGS

FIGS. 1 to 3 are schematic cross-sectional views of an operation process in which a detachable object is detached from a main body in an electronic apparatus according to a first embodiment of the present invention.

FIGS. 4 to 6 are schematic cross-sectional views of an operation process in which a detachable object is detached from a main body in an electronic apparatus according to a second embodiment of the present invention.

### DESCRIPTION OF EMBODIMENTS

### The First Embodiment

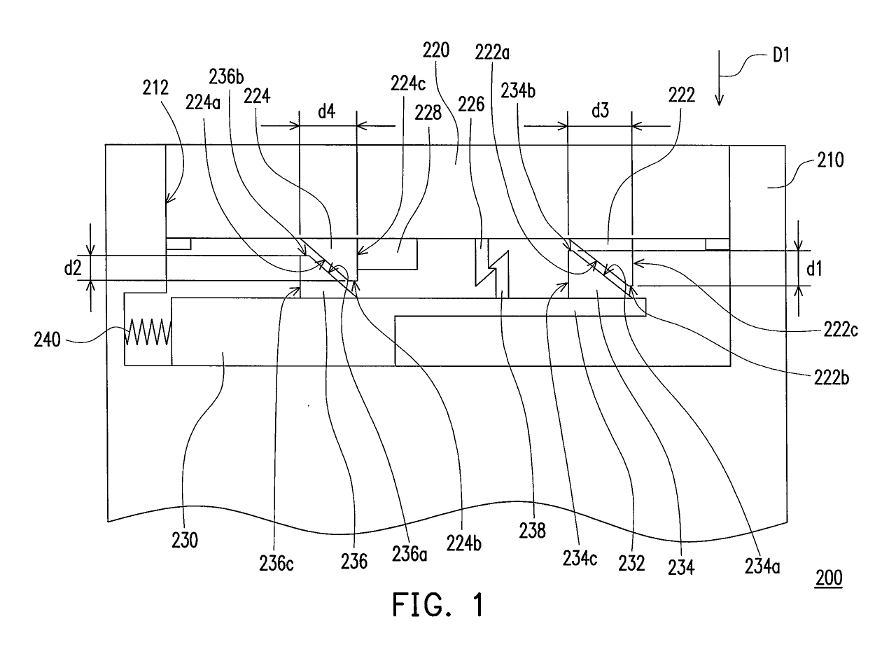

FIGS. 1 to 3 are schematic cross-sectional views of an operation process in which a detachable object is detached from a main body in an electronic apparatus according to a first embodiment of the present invention. Referring to FIG. 1, the electronic apparatus 200 of this embodiment (e.g., a host device of a portable computer) includes a main body 210, a detachable object 220 (e.g., a battery), a sliding latch element 230, and an elastic element 240. The main body 210 has an accommodating space 212. The detachable object 220 is suitable for sliding in a direction D1 to be disposed in the accommodating space 212. The detachable object 220 includes a limit part 222, a limit part 224, a locking part 226, and a protrusion 228. The limit part 222 has a slope 222a at an angle with respect to the above direction D1. The limit part 224 has a slope 224a. The protrusion 228 may be disposed between the limit part 222 and the limit part 224 and adjacent to the limit part 224.

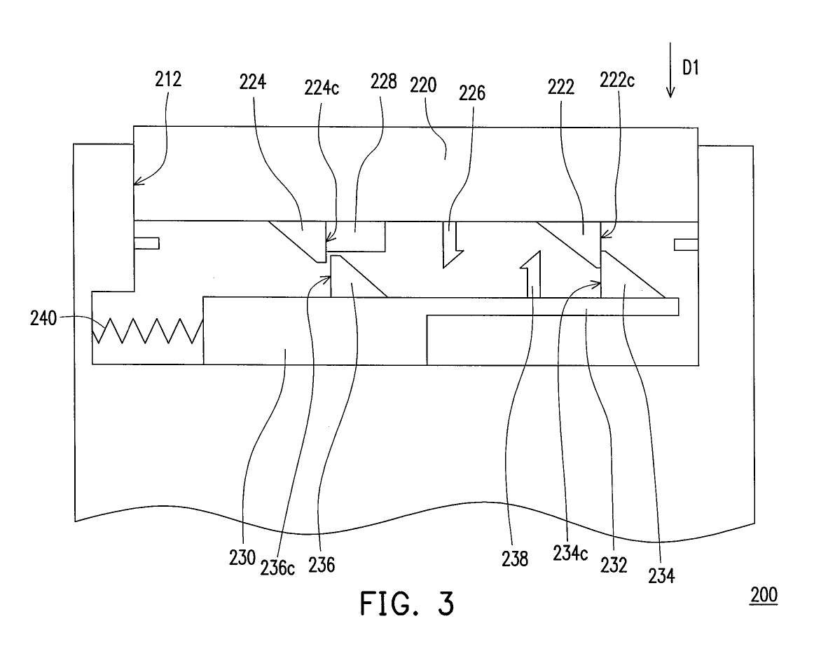

The sliding latch element 230 is suitable for sliding between a first position (as shown in FIG. 1) and a second position (as shown in FIG. 3). The sliding latch element 230 includes a flexible part 232, a limit part 234, a limit part 236, and a locking part 238. The limit part 234 is disposed on the flexible part 232, and has a slope 234a. The limit part 236 has a slope 236a. The slopes 222a, 224a, 234a, and 236a are parallel to one another. In addition, the elastic element 240 connects the sliding latch element 230 and the main body 210.

In this embodiment, the limit part 222, the limit part 224, the limit part 234, and the limit part 236 may be a wedge respectively, and the protrusion 228 may be a block. In addition, the flexible part 232 may be a flexible cantilever, the elastic element 240 may be a spring, the locking part 226 may be a locking hook, and the locking part 238 may be a locking hook. However, in another embodiment, the locking part 226 may be a locking hook, and the locking part 238 may be a locking slot. Or, the locking part 226 may be a locking slot, and the locking part 238 may be a locking hook, depending on the demands of the designer.

The operation process in which the detachable 220 is detached from the main body 210 in the electronic apparatus 200 is illustrated below. Firstly, referring to FIG. 1, when the sliding latch element 230 is at the first position as shown in FIG. 1, the detachable 220 is fixed in the accommodating space 212 by means of the locking part 226 locking the locking part 238. At this time, the slope 222a of the limit part 222 faces the slope 234a of the limit part 234, and the slope 224a of the limit part 224 faces the slope 236a of the limit part 236.

It should be noted that in this embodiment, when the sliding latch element 230 is at the first position and the detachable object 220 is fixed in the accommodating space 212, a distance d1 between a top surface 222b of the limit part 222 and a top surface 234b of the limit part 234 is greater than a distance d2 between a top surface 224b of the limit part 224 and a top surface 236b of the limit part 236. A distance d3 between a side surface 222c of the limit part 222 and a side surface 234c of the limit part 234 is greater than a distance d4 between a side surface 224c of the limit part 224 and a side surface 236c of the limit part 236.

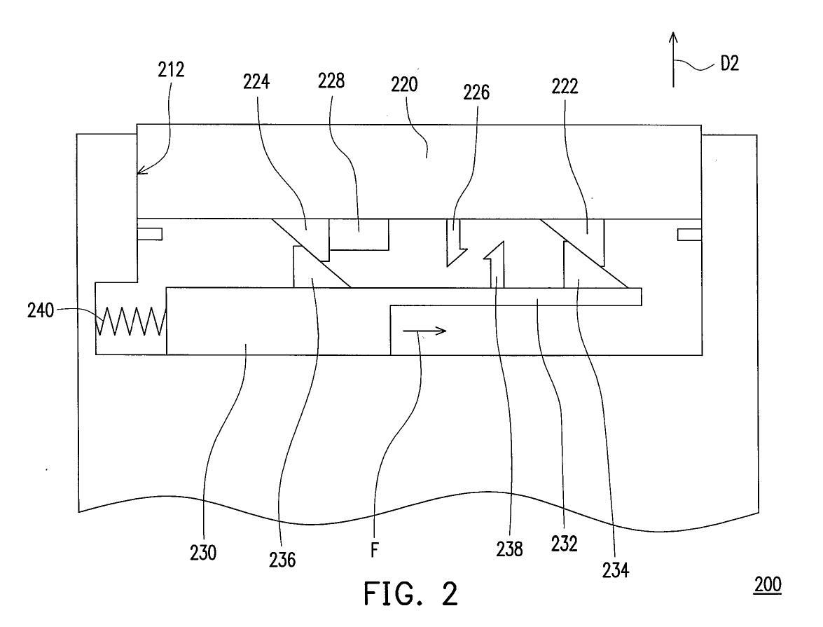

Then, referring to FIG. 2, when the sliding latch member 230 slides to leave the first position in FIG. 1 under an external force F, the locking part 226 does not lock the locking part 238, the limit part 234 pushes the limit part 222, and the limit part 236 pushes the limit part 224. Thus, the detachable object 220 moves along a direction D2 opposite to the direction D1 (as shown in FIG. 1). At this time, the flexible part 232 such as the flexible cantilever may deform flexibly (i.e., the flexible part 232 such as the flexible cantilever may be bent flexibly), and the elastic element 240 may have elastic deformation.

Then, referring to FIG. 3, when the sliding latch element 230 is at the second position as shown in FIG. 3, the locking part 226 does not lock the locking part 238, the limit part 222 blocks the limit part 234, and the limit part 236 restricts the move of the protrusion 228 along the direction D1, such that a portion of the detachable object 220 is exposed outside the accommodating space 212. In this embodiment, when the sliding latch element 230 is at the second position, the side surface 222c of the limit part 222 contacts the side surface 234c of the limit part 234, and the side surface 236c of the limit part 236 faces the side surface 224c of the limit part 224.

It should be noted when the sliding latch element 230 is at the second position, as the limit part 236 restricts the move of the protrusion 228 along the direction D1, the detachable object 220 does not easily go back to the original position due to the improperly applied forces or the weight of the detachable object 220. At this time, the user can take out the detachable object 220 conveniently. After the detachable object 220 is taken out, the sliding latch element 230 goes back to the first position of FIG. 1 due to the resilient force of the elastic element 240, wherein the direction of the resilient force is opposite to that of the external force F.

Referring to FIGS. 1, 2, and 3, the flexible part 232 such as the flexible cantilever is flexible, the elastic element 240 generates the resilient force (the direction thereof opposite to that of the external force F), and the distance d1 is greater than the distance d2. Therefore, when the sliding latch element 230 is at the second position as shown in FIG. 3, the limit part 234 will hook the limit part 222, such that the limit part 222 blocks the limit part 234. Furthermore, the distance d3 of the displacement of the limit part 234 is greater than the distance d4, and the limit part 234 hooks the limit part 222. Therefore, when the sliding latch element 230 is at the second position as shown in FIG. 3, the limit part 236 is corresponding to the protrusion 228, so as to restrict the move of the protrusion 228 along the direction D1.

In brief, under the conditions that the flexible part 232 such as the flexible cantilever is flexible, and the elastic element 240 generates the resilient force (the direction thereof opposite to that of the external force F), because the distance d1 is greater than the distance d2 and the distance d3 is greater than the distance d4, when the sliding latch element 230 is at the second position as shown in FIG. 3, the limit part 236 is corresponding to the protrusion 228, and the limit part 234 hooks the limit part 222, such that the sliding latch element 230 does not go back to the first position as shown in FIG. 1.

### The Second Embodiment

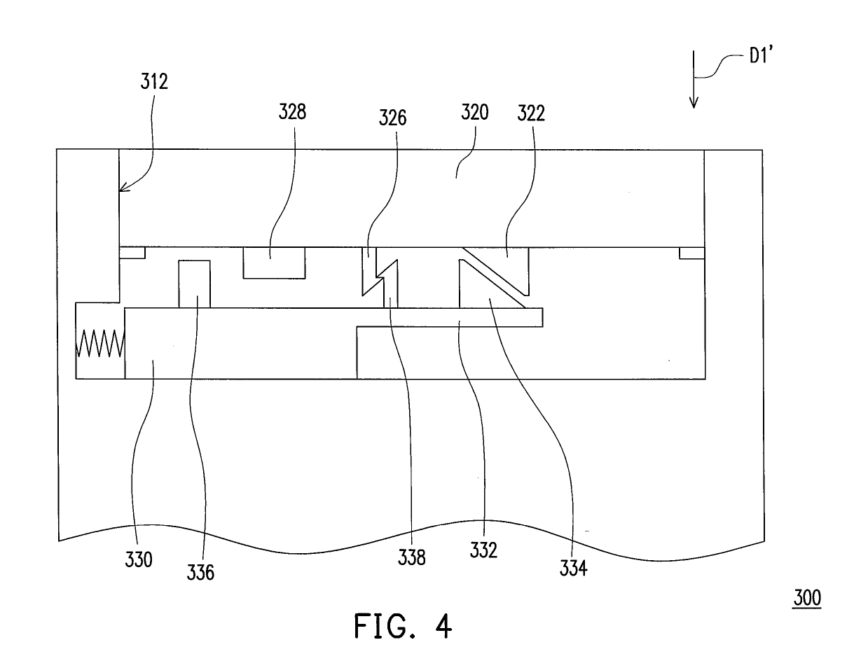

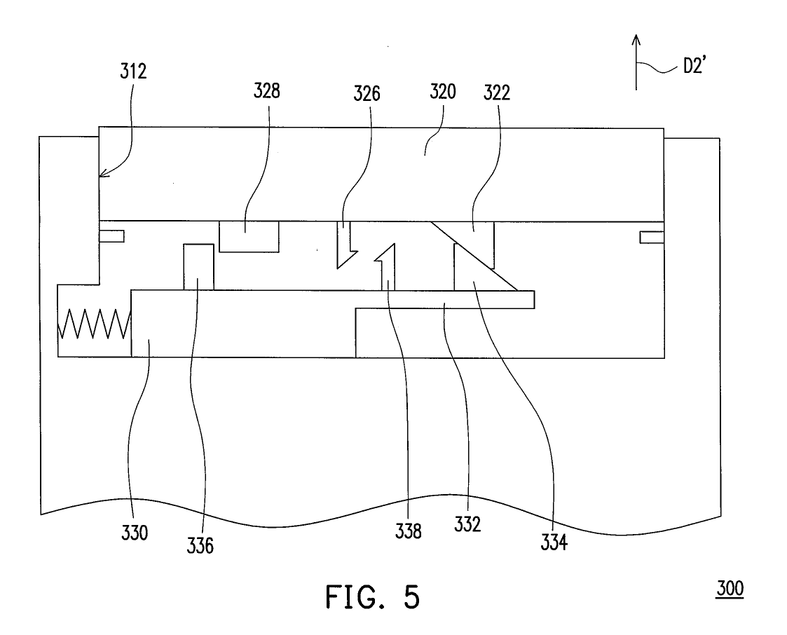

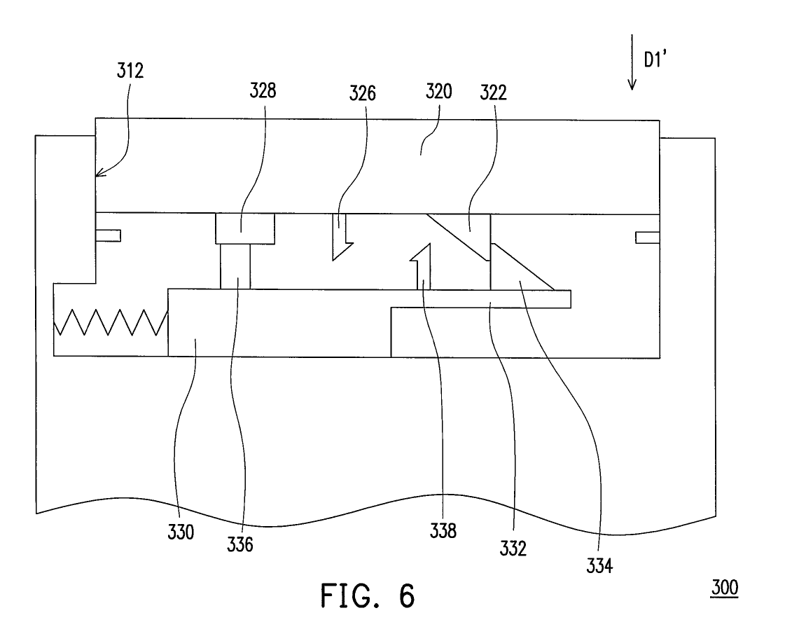

FIGS. 4 to 6 are schematic cross-sectional views of an operation process in which a detachable object is detached from a main body in an electronic apparatus according to a second embodiment of the present invention. Referring to FIGS. 4 to 6, the main difference between the electronic apparatus 300 of the second embodiment and the electronic apparatus 200 of the first embodiment is that the detachable object 320 does not include the limit part 224 (as shown in FIG. 1), the flexible part 332 such as the flexible cantilever is shorter, and the shape of the limit part 336 is different from that of the limit part 236 (as shown in FIG. 1). Therefore, when the sliding latch element 330 slides from a first position as shown in FIG. 4 to a second position as shown in FIG. 6, the limit part 334 pushes the limit part 322, such that the detachable object 320 moves along another direction D2′ opposite to the direction D1′ (as shown in FIG. 4).

It should be noted again that when the sliding latch element 330 is at the second position of FIG. 6, the locking part 326 does not lock the locking part 338, the limit part 322 blocks the limit part 334, and the limit part 336 restricts the move of the protrusion 328 along the direction D1′, such that a portion of the detachable object 320 is exposed outside the accommodating space 312.

To sum up, the electronic apparatus of the present invention at least has the following advantages.

1. As a user may move the sliding latch element to take out the detachable object, the user can take out the detachable object conveniently.

2. When the sliding latch element is at the second position, one of the limit parts of the sliding latch element restricts the protrusion of the detachable object, such that the detachable object does not slide to be disposed in the accommodating space of the main body. Therefore, the detachable object does not easily go back to the original position due to the improperly applied force or the weight of the detachable object.

3. When the sliding latch element is at the second position, one of the limit parts of the sliding latch element restricts the protrusion of the detachable object, such that the detachable object cannot slide to be disposed in the accommodating space of the main body. Therefore, as compared with the conventional art, the loose electrical contact that is not easy to be perceived will not be generated between the detachable object such as the battery and the main body such as the host device of the portable computer.

It will be apparent to persons of ordinary art in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic apparatus, comprising:
a main body, having an accommodating space;
a detachable object, suitable for sliding in a direction to be disposed in the accommodating space, wherein the detachable object comprises a first limit part, a first locking part, and a protrusion, and the first limit part has a first slope at an angle with respect to the direction;
a sliding latch element, suitable for sliding between a first position and a second position, wherein the sliding latch element comprises a flexible part, a second limit part, a third limit part, and a second locking part, and the second limit part is disposed on the flexible part and has a second slope; and
an elastic element, connecting the sliding latch element and the main body,
wherein when the sliding latch element is at the first position, the detachable object is fixed in the accommodating space by means of the first locking part locking the second locking part, and the first slope faces the second slope; when the sliding latch element is at the second position, the first locking part does not lock the second locking part, the first limit part blocks the second limit part, and the third limit part restricts the move of the protrusion along the direction, such that a portion of the detachable object is exposed outside the accommodating space.

2. The electronic apparatus as claimed in claim 1, wherein the first limit part is a wedge, and the second limit part is a wedge.

3. The electronic apparatus as claimed in claim 1, wherein the protrusion is a block.

4. The electronic apparatus as claimed in claim 1, wherein the third limit part has a third slope, and the sliding latch element further comprises a fourth limit part having a fourth slope; when the sliding latch element is at the first position, and the detachable object is fixed in the accommodating space, the third slope faces the fourth slope.

5. The electronic apparatus as claimed in claim 4, wherein the first slope, the second slope, the third slope, and the fourth slope are parallel to one another.

6. The electronic apparatus as claimed in claim 4, wherein the third limit part is a wedge, and the fourth limit part is a wedge.

7. The electronic apparatus as claimed in claim 4, wherein when the sliding latch element is at the first position, and the detachable object is fixed in the accommodating space, a first distance between a first top surface of the first limit part and a second top surface of the second limit part is greater than a second distance between a third top surface of the third limit part and a fourth top surface of the fourth limit part, and a third distance between a first side surface of the first limit part and a second side surface of the second limit part is greater than a fourth distance between a third side surface of the third limit part and a fourth side surface of the fourth limit part; when the sliding latch element is at the second position, the first side surface contacts the second side surface, and the third side surface faces the fourth side surface.

8. The electronic apparatus as claimed in claim 1, wherein the flexible part is a flexible cantilever.

9. The electronic apparatus as claimed in claim 1, wherein the first locking part is a locking hook, and the second locking part is a locking hook.

10. The electronic apparatus as claimed in claim 1, wherein the first locking part is a locking hook, and the second locking part is a locking slot.

11. The electronic apparatus as claimed in claim 1, wherein the first locking part is a locking slot, and the second locking part is a locking hook.
